(19) United States
(12) Patent Application Publication
(10) Pub. No.: US 2025/0320009 A1
(43) Pub. Date: Oct. 16, 2025

(54) METHOD AND APPARATUS FOR OBJECT CLOSING

(71) Applicants: Scitech Center, Mumbai (IN); ACG Pam Pharma Technologies Pvt Ltd, Mumbai (IN)

(72) Inventors: Karan Singh, Mumbai (IN); Werner Bongers, Mumbai (IN); Stefan Kemner, Mumbai (IN); Sumit Waghmare, Mumbai (IN); Priyabrata Sahu, Mumbai (IN); Dhruv Prajapati, Mumbai (IN)

(21) Appl. No.: 18/277,990

(22) PCT Filed: May 29, 2023
(86) PCT No.: PCT/IB2023/055482

§ 371 Date: Aug. 20, 2023

(30) Foreign Application Priority Data
Jan. 5, 2023 (IN) 202321000822

(51) Int. Cl. B65B 7/20; B65B 51/02

(52) U.S. Cl. CPC B65B 7/20; B65B 51/02

(57) ABSTRACT

The present disclosure pertains to the field of box closing devices, in particular, to a device for closing successively, boxes. The present invention in one aspect provides a device for closing an open box. The device comprises a drive track having an entrance portion for receiving and engaging an open flap of the box which merges through a gradually curved portion to a downstream portion. The downstream portion comprises means for completing the tucking in of the opened flap and for supporting a box moved therealong. The curved portion comprises means for initiating the tucking in of the opened flap by a transferring means for transferring the open box from the entrance through the downstream portion and then an engaging means for subsequently tucking any partially tucked pair of flaps.

### PRIORITY APPLICATION DETAILS

The present application claims the priority from the Indian patent application Ser. No. 202321000822 dated Jan. 5, 2023, having a title as—METHOD AND APPARATUS FOR OBJECT CLOSING.

### FIELD OF THE INVENTION

The present disclosure pertains to the field of box closing devices, in particular, to a device for closing successively, boxes having flaps to be folded over open ends of the box and more particularly, by allowing the closing of the main flap and the bending and insertion of the insertion flap to be performed continuously.

### BACKGROUND OF THE INVENTION

Boxes are used to pack different kinds of products thereby protecting the contents/products accommodated inside from the external environment. In the packaging industry boxes come in different sizes which are made from a wide variety of materials. Generally, boxes are foldable and are formed from a flattened state. Such foldable boxes are manufactured from an assortment of foldable materials, including but not limited to cardboard, paper, chipboard, paperboard, corrugated fibreboard, other types of corrugated materials, plastic materials, composite materials and combinations thereof.

Conventionally, empty boxes are serially retrieved from a flattened state, reconfigured from the flattened state into an erected state, and placed in a slot on a box conveyor. The erected boxes are then moved by the box conveyor to a loading station where the boxes are filled with one or more items or products followed by closing. Alternatively, the boxes have one side closed by folding and closing the bottom flaps, and then be loaded or filled with one or more items or products from the opposite side while on the box conveyor. In one of such configuration, an open end of the box faces perpendicularly to a conveyor on which the box may be conveyed, and the items or products are “side-loaded” substantially horizontally into the box. At times, the boxes can be reoriented from a side orientation to an upright orientation with the opening facing upwardly. The erected box can then be moved to a loading station or loading system where it can be “top-loaded”. Subsequently, any required additional flap closing (folding) and closing is carried out to enclose and completely close and seal the box with one or more items or products contained therein.

Given the current advances in automated packaging industry and the increasingly improved techniques for the high-speed manufacture and packaging of consumer goods, the ability to quickly and effectively package the product for shipment is one of the primary factors for success of a manufacturing or wholesaling operation. However, it has been found that the most common impediment to high production output is the inability of the present methods and equipment to pack the finished product rapidly and effectively for shipment at a speed commensurate with the product output capability of the plant. Especially in the pharmaceutical industry, where great strides have been made in high speed techniques for dispensing the product into different sized boxes.

Most of the conventionally disclosed packaging systems are configured to perform only a part of the process and at times even requires an additional device or manpower to close the box once the product has been loaded. Also, another point of concern in folding the flap of a box is that the adjoining side panel may tend to buckle inwardly between its margins and toward the opposed side panel because of the particular construction of the side panel or because of flimsiness of the material. Such buckling destroys the rectangularity of the box and causes the flap to become tilted relative to the other panels and the open end of the box so that the flap is positioned improperly for folding across the end of the box thus resulting in imperfect closing of many boxes, thereby causing frequent interruptions.

There exists a need for a need for a device for closing an open box which solves the above-mentioned conventional problems and improves the productivity and reliability of the product packaging by allowing the folding process of the box to be performed quickly and stably.

### SUMMARY OF THE INVENTION

Accordingly, the present invention in one aspect provides a device 100 for closing an open box. The device comprises a drive track 101 having an entrance portion 103 for receiving and engaging an open flap of the box which merges through a gradually curved portion to a downstream portion 105. The downstream portion 105 comprises means for completing the tucking in of the opened flap and for supporting a box moved there along. The curved portion comprises means for initiating the tucking in of the opened flap by a transferring means for transferring the open box from the entrance through the downstream portion and then an engaging means 107 for subsequently tucking any partially tucked pair of flaps.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1 illustrates an exemplary diagram of a device for closing an open box, in accordance with some embodiments of the present disclosure.

FIG. 2 illustrates an exemplary diagram of a device for closing an open box, in accordance with some embodiments of the present disclosure.

FIG. 3 illustrates an exemplary diagram of a device for closing an open box, in accordance with some embodiments of the present disclosure.

### DETAILED DESCRIPTION OF THE INVENTION

The following is a detailed description of embodiments of the present disclosure. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

Unless the context requires otherwise, throughout the specification which follow, the word “comprise” and variations thereof, such as, “comprises” and “comprising” are to be construed in an open, inclusive sense that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

In some embodiments, the numbers expressing quantities of ingredients, properties such as concentration, and so forth, used to describe and claim certain embodiments of the invention are to be understood as being modified in some instances by the term “about.” Accordingly, in some embodiments, the numerical parameters set forth in the written description are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable.

The recitation of ranges of values herein is merely intended to serve as a shorthand method of referring individually to each separate value falling within the range. Unless otherwise indicated herein, each individual value is incorporated into the specification as if it were individually recited herein.

All methods described herein can be performed in suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

The headings and abstract of the invention provided herein are for convenience only and do not interpret the scope or meaning of the embodiments.

Various terms are used herein. To the extent a term used in a claim is not defined below, it should be given the broadest definition persons in the pertinent art have given that term as reflected in printed publications and issued patents at the time of filing.

In this disclosure, including the claims, the words “box” is used to refer to boxes, cartons, and/or cases that can be used to package any type of items including products and/or other cartons. The word “carton” is used interchangeably with “box” or “case”.

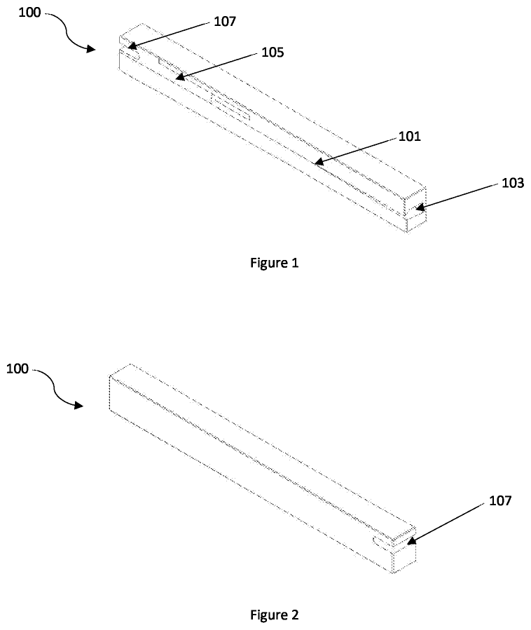

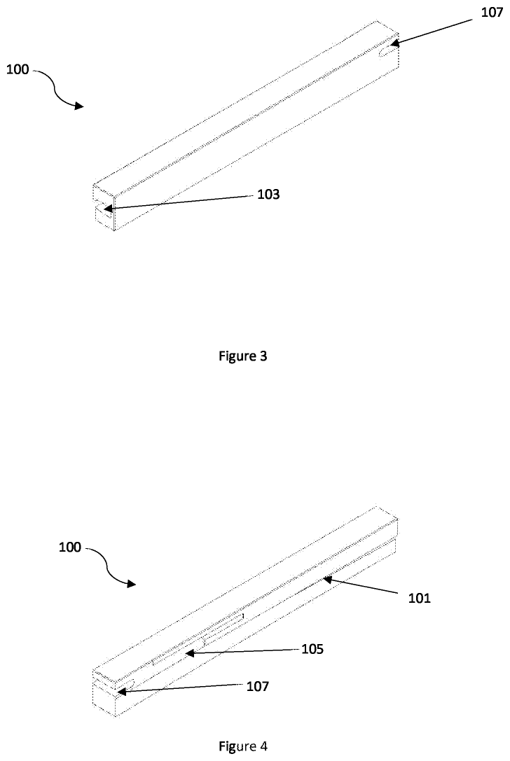

The present invention discloses a device for successively closing boxes. FIG. 1 indicates a device 100 for closing an open box. The device comprises a drive track 101 having an entrance portion 103 for receiving and engaging an open flap of the box. The drive track 101 further merges through a gradually curved portion to a downstream portion 105 which comprises means for completing the tucking in of the opened flap and for supporting a box moved therealong. The curved portion comprises means for initiating the tucking in of the opened flap by transferring means for transferring the open box from the entrance through the downstream portion and engaging means 107 for subsequently tucking any partially tucked pair of flaps.

Referring to FIG. 1, a plurality of open boxes, comprising the intended product/s therein, are maintained in a single row. Typically, the open boxes are lined on an input platform top or a conventional conveyor (not shown in the figure) having predetermined guide rails. The conveyors move at a predetermined speed such that the open boxes are successively driven through the entrance portion 103 of the drive track 101. In an embodiment of the present invention, the speed of the conveyors is variable. In an exemplary embodiment the open boxes comprising the intended product/s are lined up such that at least two open boxes are mounted one above the other for simultaneous closing of the at least two open boxes.

Typically, the transferring means comprises a horizontal guide member and stop bar member disposed parallel to the plate such that the distance between the horizontal guide member and the stop bar member is slightly bigger than the box width. The transferring means prevents the unwanted movement of the box while the box travels over the horizontal guide member.

The device 100 optionally comprises a means for applying glue to the opened flap disposed below the downstream portion. The device 100 further comprises a locking means for locking the flaps of the tucked box.

Referring to FIG. 1, the open boxes enter the device from the right (as viewed in FIG. 1) and are then conveyed through the entrance portion 103 along the drive track 101. The boxes (not shown in the figure) are open as they enter the device and as they travel through the drive track 101 which merges through a gradually curved portion to a downstream portion 105, the open boxes are tucked in (closed). However, as will hereinafter become apparent, the device as shown, with only slight modifications, is adapted to receive boxes with variable dimensions.

As mentioned herein above, the device 100 comprise a drive track 101 having an entrance portion 103 such that the entrance portion 103 for receiving and engaging an open flap of the box comprises a plurality of apertures for blowing compressed air. In an exemplary embodiment of the present invention, the plurality of apertures reduce the damage to the open flaps of the box by reducing the friction.

In an embodiment of the present invention, the device 100 can be retrofitted in a conventional box packaging system.

While the foregoing description discloses various embodiments of the

disclosure, other and further embodiments of the invention may be devised without departing from the basic scope of the disclosure.

We claim:

1. A device for closing an open box comprising:
a drive track having an entrance portion for receiving and engaging an open flap of said box which merges through a gradually curved portion to a downstream portion which comprises means for completing the tucking in of said opened flap and for supporting a box moved therealong;
wherein said curved portion comprises means for initiating the tucking in of said opened flap by;
transferring means for transferring said open box from said entrance through said downstream portion; and
engaging means for subsequently tucking any partially tucked pair of flaps.

2. The device as claimed in claim 1, wherein said transferring means comprises a horizontal guide member and stop bar member disposed parallel to said plate such that the distance between said horizontal guide member and said stop bar member is slightly bigger than said box width.

3. The device as claimed in claim 1, wherein said transferring means prevents the unwanted movement of said box.

4. The device as claimed in claim 2, wherein said box travels over said horizontal guide member.

5. The device as claimed in claim 1, wherein said device optionally comprises a means for applying glue to said opened flap disposed below said downstream portion.

6. The device as claimed in claim 1, wherein said device optionally comprises a locking means for locking the flaps of said tucked box.

7. The device as claimed in claim 1, wherein said entrance portion for receiving and engaging an open flap of said box comprises a plurality of apertures for blowing compressed air;
wherein said plurality of apertures reduce the damage to the open flaps of said box by reducing the friction.

8. The device as claimed in claim 1, wherein said device can be retrofitted in a conventional box packaging system.
